(19) United States
(12) Patent Application Publication
(10) Pub. No.: US 2026/0046905 A1
(43) Pub. Date: Feb. 12, 2026

(54) MODE 1 RESOURCE ALLOCATION FOR SIDELINK TRANSMISSIONS IN UNLICENSED SPECTRUM

(71) Applicant: Apple Inc., Cupertino, CA (US)

(72) Inventors: Chunxuan Ye, San Diego, CA (US); Dawei Zhang, Saratoga, CA (US); Wei Zeng, Saratoga, CA (US); Hong He, San Jose, CA (US); Sigen Ye, Whitehouse Station, NJ (US); Huaning Niu, San Jose, CA (US); Haitong Sun, Cupertino, CA (US); Seyed Ali Akbar Fakoorian, San Diego, CA (US); Oghenekome Oteri, San Diego, CA (US); Chunhai Yao, Beijing (CN)

(21) Appl. No.: 19/103,172

(22) PCT Filed: Aug. 12, 2022
(86) PCT No.: PCT/CN2022/112166

§ 371 Date: Feb. 11, 2025

(51) Int. Cl. H04W 72/25; H04L 5/00; H04W 72/232; H04W 74/0808

(52) U.S. Cl. CPC H04W 72/25; H04L 5/0055; H04W 72/232; H04W 74/0808

(57) ABSTRACT

Systems and processes are described for resource allocation for new radio (NR) sidelink transmissions in an unlicensed spectru (NR-U). More specifically, the resource allocation is performed for mode 1 sidelink transmissions. The methods and systems include a time gap field that is configured to indicate a time gap between downlink control information (DCI) format 3_0 transmissions and Physical Sidelink Control Channel (PSCCH) or Physical Sidelink Shared Channel (PSSCH) transmissions.

### TECHNICAL FIELD

This disclosure relates generally to sidelink (SL) transmissions in wireless communications.

### BACKGROUND

Wireless communication systems are rapidly growing in usage. Further, wireless communication technology has evolved from voice-only communications to also include the transmission of data, such as Internet and multimedia content, to a variety of devices. To accommodate a growing number of devices communicating both voice and data signals, many wireless communication systems share the available communication channel resources among devices.

### SUMMARY

This specification describes processes for resource allocation for new radio (NR) sidelink transmissions in an unlicensed spectrum (NR-U). More specifically, the resource allocation is performed for mode 1 sidelink transmissions. The methods and systems include a time gap field that is configured to indicate a time gap between downlink control information (DCI) format 3_0 transmissions and Physical Sidelink Control Channel (PSCCH) or Physical Sidelink Shared Channel (PSSCH) transmissions. In another example, DCI 3_0 includes a field specifying a Physical Sidelink Feedback Channel to Hybrid Automatic Repeat Request (PSFCH-to-HARQ) feedback timing indicator. In another example, the systems and processes include a resource re-evaluation or pre-emption process mandatorily prior to resource allocation. If needed, an additional time gap is added. The systems and operations described herein can be related to Release 18 of the 5th Generation (5G) of the 3rd Generation Partnership Project (3GPP).

Generally, unlicensed spectrum, or free bands, that are available for transmissions. For example, these bands can include 2.4 and 5 GHz. A Listen Before Talk (LBT) protocol enables user equipment (UEs) to use the unlicensed spectrum while maintaining equitable access with respect to the WiFi devices. Specifically, the processes herein are to avoid collisions with WiFi transmissions. The systems and processes described in this specification are configured for mode 1 in which Uu operation for mode 1 uses the licensed spectrum only (e.g., RAN1, RAN2, and RAN4). Generally, the channel access mechanisms from NR-U are reused for unlicensed sidelink operations.

Generally, the sidelink mode 1 resource allocation (RA) includes a dynamic grant. Each of Type 1 and Type 2 configured grants are supported as a baseline for sidelink operation in a shared carrier, subject to applicable regional regulations. At least in dynamic channel access, a SL UE performs Type 1 or one of the Type 2 LBT operations before SL transmission using the allocated resource(s). The UE still performs the LBT operations because of the potential conflict with WiFi transmissions. The LBT operations are performed in compliance with a transmission gap and LBT sensing idle time requirements, such as those specified in TS 137.213.

The systems and processes described in this specification enable one or more advantages. The systems and methods described herein enhance mode 1 resource allocation on shared spectrum channel access to prevent collisions, such as with WiFi transmissions. The enhanced resource allowance for unlicensed SL transmissions in mode 1 include a timeline consideration for LBT sensing to allow for LBT operations in the dynamic allocation. A SL HARQ report is generated for a node (e.g., a base station, next generation node gNB, access point, etc.) for scenarios including multiple PSFCH occasions. The enhanced resource allocation updates the SL configured grant. The enhanced resource allocation accommodates timeline restrictions for resource re-evaluation and pre-emption on shared spectrum channel access. For example, the SL UE performs Type 1 LBT operations or Type 2 LBT operations before SL transmission. For a Type 1 LBT, which is a more general LBT, the LBT sensing duration is flexible depending on a Channel access priority class (CAPC) value. A transmitted two-bit value indicates which channel access priority is being used by an initiating UE to acquire the channel occupancy time (COT) for a SL transmission. For a type 2 LBT, a sensing duration is selected (e.g., 0-25 microseconds (us)) based on the specific LBT operations being performed. The enhanced resource allowance enables the different LBT operations to be performed without collision.

The one or more advantages can be enabled by at least one or more of the following embodiments described in an examples section below.

In some implementations, the process is performed by a network element, a UE, or base station, such as a next generation node (gNB). In some implementations, one or more non-transitory computer readable media store instructions that when executed by at least one processing device cause the at least one processing device (or another device in communication with the at least one processing device) to perform the process.

The details of one or more implementations are set forth in the accompanying drawings and the description below. Other features and advantages will be apparent from the description and drawings, and from the claims.

### BRIEF DESCRIPTION OF DRAWINGS

FIG. 1 illustrates a wireless network, in accordance with some embodiments.

FIG. 2 shows an illustration of an example transmission timeline for a UE for SL transmissions.

FIG. 3 shows an illustration of an example transmission timeline for a UE for SL transmissions in the unlicensed spectrum.

FIG. 4 shows an illustration of an example transmission timeline for a UE for SL transmissions.

FIG. 5 shows an illustration of an example transmission timeline for a UE for configured grant Type 1 SL transmissions.

FIG. 6 shows an illustration of example transmission timelines for a UE for SL transmissions.

FIG. 7 shows a flow diagram of an example process for resource allocation for mode 1 SL transmissions by a UE in an unlicensed spectrum.

FIG. 8 shows a flow diagram of an example process for resource allocation for mode 1 SL transmissions by a UE in an unlicensed spectrum.

FIG. 9 shows a flow diagram of an example process for resource allocation for mode 1 SL transmissions by a UE in an unlicensed spectrum.

FIG. 10 shows a flow diagram of an example process for resource allocation for mode 1 SL transmissions by a UE in an unlicensed spectrum.

FIG. 11 shows a flow diagram of an example process for resource allocation for mode 1 SL transmissions by a UE in an unlicensed spectrum.

FIG. 12 illustrates a user equipment (UE), in accordance with some embodiments.

FIG. 13 illustrates an access node, in accordance with some embodiments.

Like reference symbols in the various drawings indicate like elements, according to various embodiments herein.

### DETAILED DESCRIPTION

This specification describes systems and processes to enable enhanced sidelink (SL) resource allocation for transmissions in mode 1 when using an unlicensed spectrum (NR-U), such as by user equipment (UE). Generally, the SL UE performs Type 1 LBT operations or one of the one or more sets of Type 2 LBT operations before performing an SL transmission. The different LBTs have different respective configurations. The Type 1 LBT includes an LBT sensing duration that is flexible depending on an associated CAPC value, as shown in Table 1 or Table 2, below. A two-bit value is generated that indicates which channel access priority is being used by the initiating device to acquire the COT for a SL transmission. Generally, either the downlink (DL) CAPC value from Table 1 or the uplink (UL) CAPC value from Table 2 can be used for the SL resource allocation. Generally, a maximum LBT sensing idle time is 1023*9 μs (e.g., the sensing slot duration), which is about 9 milliseconds (ms), or several slots. For type two, the following configurations are typically used. A Type 2A LBT is associated with a LBT sensing duration of 25 μs. A Type 2B LBT is associated with a sensing duration between 16 and 25 μs. A Type 2C LBT does not include a channel sensing operation before transmission. Rather, if the spectrum is free, it is used, without a countdown or calculation of the CW. A time gap to a previous transmission is less than 16 μs. A duration of a corresponding transmission is less than or equal to 584 μs.

TABLE 1
Downlink configurations for NR-U (gNB) for Type 1 LBT

| Channel | | | | | | |
|---|---|---|---|---|---|---|
| Access | | | | | | |
| Priority | | | | | | |
| Class | | | | | | |
| (p) | mₚ | CW_{min, p} | CW_{max, p} | T_{mcot, p} | | allowed CWₚ sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, 127, 255, 511, 1023} |

As shown in Table 1, mₚ is maximum number of transmission attempts for priority class p. CWₚ is a contention window for a given priority class p. CW_{max, p} is a maximum contention window for a given priority class, p. CW_{min, p} is a minimum contention window for a given priority class, p. T_{cot, pm} is a maximum channel occupancy time for a given priority class, p. According to the 3GPP standards, a device does not continuously transmit in the unlicensed spectrum for a period longer than T_{mcot, p}. The allowed CW sizes for each priority class for DL are shown in Table 1.

TABLE 2
Uplink configurations for NR-U (UE) for Type 1 LBT

| Channel | | | | | |
|---|---|---|---|---|---|
| Access | | | | | |
| Priority | | | | | |
| Class | | | | | |
| (p) | mₚ | CW_{min, p} | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, 255, 511, 1023} |
| 4 | 7 | 15 | 1023 | 6 ms or 10 ms | {15, 31, 63, 127, 255, 511, 1023} |

As shown in Table 2, mₚ is maximum number of transmission attempts for priority class p. CWₚ is a contention window for a given priority class p. CW_{max, p} is a maximum contention window for a given priority class, p. CW_{min, p} is a minimum contention window for a given priority class, p. T_{cot, pm} is a maximum channel occupancy time for a given priority class, p. According to the 3GPP standards, a device does not continuously transmit in the unlicensed spectrum for a period longer than T_{mcot, p}. The allowed CW sizes for each priority class for UL are shown in Table 2.

The enhanced resource allocation for SL transmissions using the unlicensed spectrum in mode 1 is based on the following process for SL transmissions. A node (e.g., a gNB) is configured to schedule NR sidelink resources to be used by a UE for sidelink transmissions. First, a request is sent by the initiating device (e.g., the UE) for sidelink scheduling. The request can include a scheduling request (SR) and a buffer status report (BSR). Generally, the SR report notifies the node that there is data to transmit at the UE. Generally, the BSR is a MAC control element (CE) from a UE to the node (network) carrying information on how much data is in the UE buffer for transmission.

Based on the SR and/or BSR, the node may then perform SL grant operation. For a SL grant, the node can perform a dynamic grant, a configured grant type 1, or a configured grant type 2. Generally, the SL grant includes an allocation of PSCCH and/or PSSCH resources. In some implementations, a DCI format 3_0 is used for SL grant. The UE sends SL data to a device (e.g., another UE), and receives HARQ feedback from the other UE. The UE sends the received SL HARQ feedback report to the node. This occurs if the node provides Physical Uplink Control Channel (PUCCH) resources for feedback in the allocation. The node can perform a SL grant for retransmission, such as in response to receiving a negative acknowledgement (NACK) for a prior transmission.

Generally, in NR SL transmissions, there is a time gap greater than T_{proc} between the DCI 3_0 transmission from the node to the UE for SL dynamic or SL configured grant type 2. The UE SL transmission occurs, and a gap is present until the SL HARQ is received. There is a slot offset between the SL HARQ and the SL HARQ report to the node from the UE. This is not multiplexed with the uplink control information (UCI). When a NACK is performed, there is a dynamic grant for SL ReTx.

The node and/or UE can perform SL resource allocation for mode 1 in the unlicensed spectrum by adjusting the SL resource allocation process in one or more of the following ways. In an example, timeline restrictions are imposed in mode 1 resource allocation. This approach, subsequently described in greater detail, includes using a time gap field in the DCI 3_0 format to indicate a gap between the DCI 3_0 and the PSCCH/PSSCH. In another example, the SL HARQ report in mode 1 resource allocation is modified. DCI 3_0 include includes a field for the PSFCH-to-HARQ feedback timing indicator. In this example, for the case of multiple PSFCH transmission occasions (to address LBT failure issue), the last PSFCH occasion is used by the UE to determine a timing of a PUCCH transmission with the SL HARQ report to the node. In some implementations, multiple PUCCH occasions are allocated, and each occasion corresponds to a candidate PSFCH transmission occasion. Either a same or multiple different PSFCH-to-HARQ feedback timing indicator value(s) in DCI 3_0 are used to determine the multiple PUCCH occasions. In another example, a SL configured grant is used for SL resource allocation for mode 1 in the unlicensed spectrum. In another example, the UE uses a timing of resource re-evaluation and preemption process for SL resource allocation in mode 1 for the unlicensed spectrum (NR-U). Each of these examples is subsequently described in further detail. Each of these examples enhances mode 1 resource allocation on shared spectrum channel access by providing a timeline consideration for LBT sensing, a SL HARQ report to the base station in case of multiple PSFCH occasion, and a SL configured grant configuration.

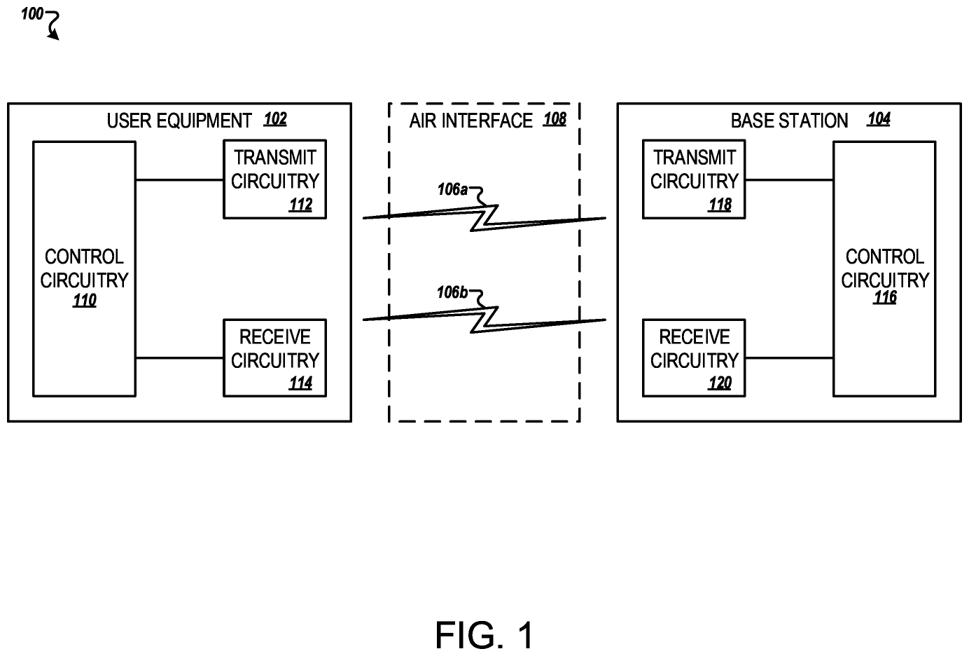

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare monitoring, remote security surveillance systems, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations associated with selection of codecs for communication and to adaption of codecs for wireless communications as part of system congestion control. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry, including communications using codecs as described herein.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116 may be adapted to perform operations for analyzing and selecting codecs, managing congestion control and bandwidth limitation communications from a base station, determining whether a base station is codec aware, and communicating with a codec-aware base station to manage codec selection for various communication operations described herein. The transmit circuitry 118 and receive circuitry 120 may be adapted to transmit and receive data, respectively, to any UE connected to the base station 104 using data generated with various codecs described herein. The transmit circuitry 118 may transmit downlink physical channels includes of a plurality of downlink sub-frames. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data via a ProSe interface. The ProSe interface may alternatively be referred to as a SL interface and may include one or more logical channels, including but not limited to a PSCCH, a PSSCH, a PSDCH, and a PSBCH.

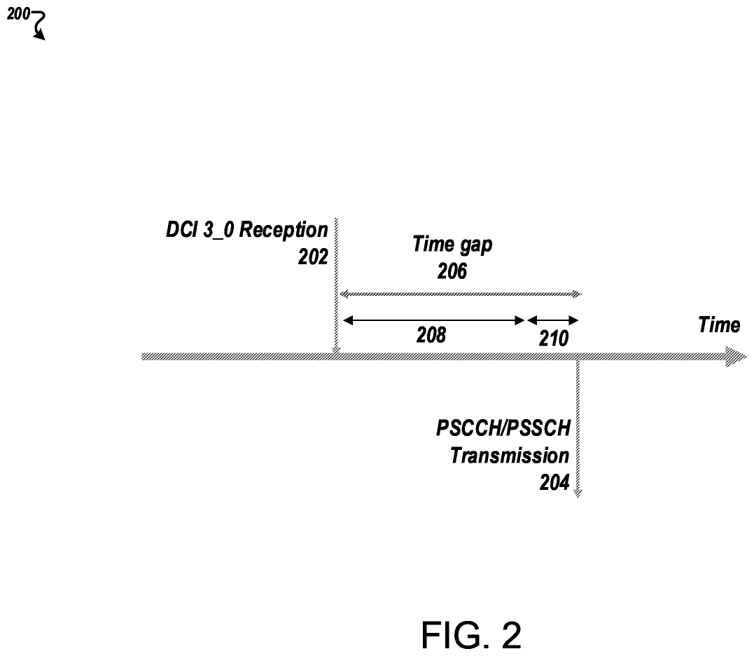

FIG. 2 shows an illustration of an example transmission timeline 200 for a UE (e.g., UE 102 of FIG. 1) for SL transmissions. The UE is configured to perform SL resource allocation based on timeline restrictions in mode 1 resource allocation. In timeline 200, a time gap 206 is shown between a DCI 3_0 reception 202 and a PSCCH/PSSCH transmission 204 by the UE. The time gap 206 length is specified in a field of the DCI 3_0 data. The time gap field indicates the time gap 206 between the DCI 3_0 data reception and the PSCCH/PSSCH transmission. Specifically, the value of the time gap field indicates a value of an index of a table “sl-DCI-ToSL-Trans,” which stores a value of the time gap 206 associated with the index value. When the UE is to perform LBT operations before an initial PSCCH/PSSCH transmission, the time gap 206 can be lengthened to enable for LBT operations (e.g., type 1 or type 1 LBT) by the UE.

The UE can determine the value of time the time gap in different ways. In an example, the value of the time gap is equal to a value indicated by the table “sl-DCI-ToSL-Trans.” In this case, each the time gap specified in the table is used as specified in the table, and there is no adjustment made to this value by the UE specifically for the LBT operations. Rather, the UE is not expected to have the time gap 206 size that is smaller than a threshold value based on the LBT type and the CAPC index. In this example, the time gap 206 length specified by the table is long enough to accommodate the LBT operations for a given LBT type and CAPC index value. In some implementations, the values of the time gap 206 specified in the table “sl-DCI-ToSL-Trans” are lengthened relative to legacy values to accommodate LBT operations by the UE to ensure that each time gap is longer than a threshold value of time needed for the LBT operations. In some implementations, if the time gap 206 specified by the DCI 3_0 transmission 202 is less than a threshold value, the resource allocation is rejected.

Rather than use the time gap value directly, the UE can be configured to add an offset 210 length of time to the time gap 208 specified by the table “sl-DCI-ToSL-Trans.” The time gap 206 used by the UE is equal to an offset 210 added on the time gap value 208 indicated by the “sl-DCI-ToSL-Trans” table. In this example, the time gap values specified in the table may be the same as for legacy operations. The added offset ensures that the UE has allocated time for LBT operations. The offset value 210 depends on the value of the CAPC index of the LBT operation of the UE (e.g., as previously shown in Tables 1 and 2). In an example, for a larger CAPC index, a larger the offset value is provided. The value of the CAPC index is included in the DCI 3_0 transmission 202. The value of the offset 210 can be stored in a table with the CAPC index values. In some implementations, the offset 210 can be a function of the CAPC index value. For example, the offset value 208 can be a function of the CW or other values of Tables 1 and 2. In some implementations, a mapping between each CAPC index and an offset value 210 is (pre)configured for each resource pool.

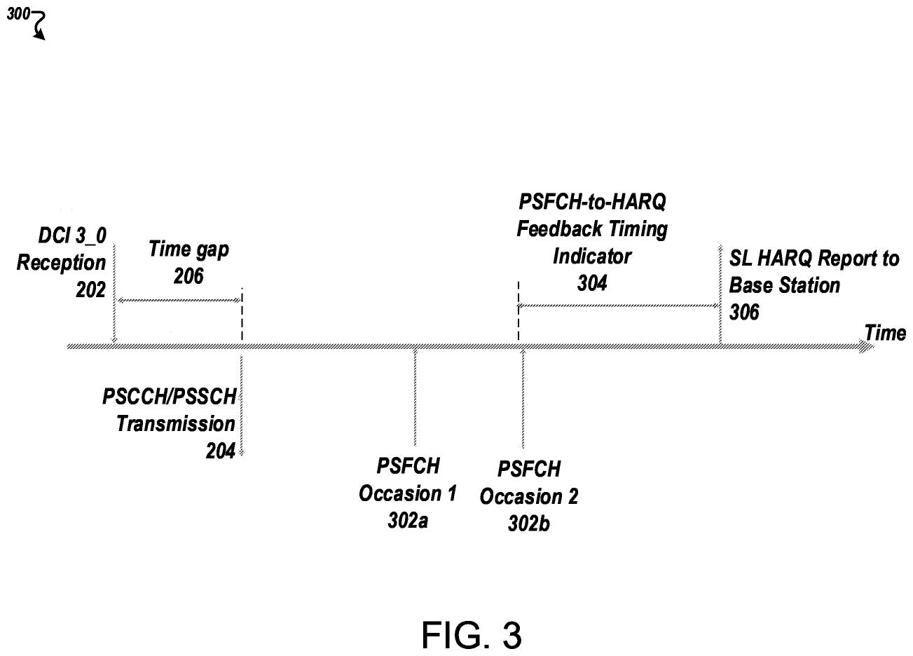

FIG. 3 shows an illustration of an example transmission timeline 300 for a UE (e.g., UE 102 of FIG. 1) for SL transmissions in the unlicensed spectrum. The timeline 300 shows a feedback configuration based on the resource allocation. The SL HARQ report 306 in mode 1 resource allocation is used to determine the resource allocation for SL transmissions. Generally, because the UE is operating using the unlicensed spectrum, LBT failure is possible, and multiple PSFCH transmission occasions 302a, 302b may be required. This is in contrast to the licensed spectrum in which a single PSFCH occasion is used.

The timing for the UE to report the HARQ feedback to the base station is as follows. For the multiple PSFCH feedback occasions 302a-b, a time gap 304 is configured based on a PSFCH-to-HARQ feedback timing indicator value. The time gap 304 generally is measured between the last possible PSFCH occasion 302b and the feedback 306.

The UE can determine the time gap 304 based on a last PSFCH occasion. The time gap 304 specifies a timing of a PUCCH transmission with the SL HARQ report 306 to the base station (e.g., base station 104 of FIG. 1). Generally, the contents of SL HARQ report 306 to the base station depend on the multiple PSFCH feedback occasions 302a-b associated with the PSCCH/PSSCH transmission 204. Generally, if the PSFCH occasion 302a-b is within a time window, the last PSFCH occasion 302b is the end of the time window. The end of the time window is the start of the determined time gap 304.

The UE can perform SL unicast. In this case, if a HARQ ACK is received by the UE in any of the PSFCH occasions 302a-b, the UE sends the SL HARQ report 306 to the base station as an “ACK” transmission. If no HARQ ACK is received by the UE in any of the PSFCH occasions 302a-b, the UE sends the SL HARQ report 306 to the base station as a “NACK” transmission. While two PSFCH occasions 302a-b are shown, the number of PSFCH occasions can be greater than two, and the subsequent occasions and corresponding transmission allocations are configured in a similar manner as for PSFCH occasions 302a-b.

The UE can perform SL groupcast ACK/NACK transmission. In this case, if a HARQ ACK is received for each of receiver UE in any of the PSFCH occasions 302a-b, the UE sends the SL HARQ report 306 to the base station as an “ACK” transmission. If any PSFCH occasion 302a-b received by the UE does not include a HARQ ACK, the UE sends the SL HARQ report 306 to the base station as a “NACK” transmission.

The UE can perform SL groupcast NACK-only transmission. In this case, if a HARQ NACK is received by the UE for any of the PSFCH occasions 302a-b, the UE sends the SL HARQ report 306 to the base station as a “NACK” transmission. If no PSFCH occasion 302a-b received by the UE includes a HARQ NACK, the UE sends the SL HARQ report 306 to the base station as an “ACK” transmission. The UE reporting to the base station is either ACK/NACK, thought the UE-UE transmissions are NACK only. This is because the base station determines whether to schedule for retransmission based on the received ACK/NACK data in the report 306.

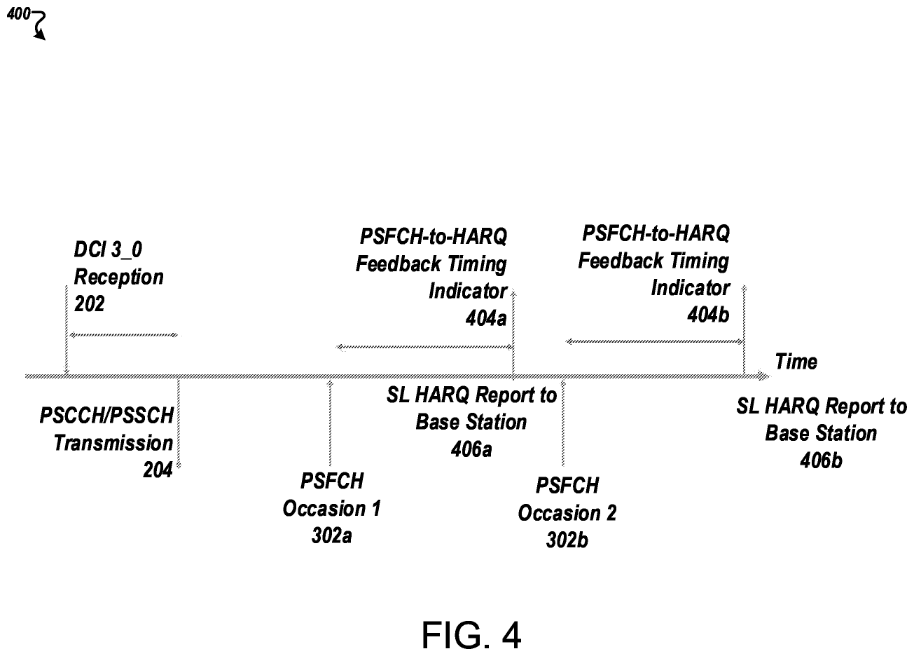

FIG. 4 shows an illustration of an example transmission timeline 400 for a UE (e.g., UE 102 of FIG. 1) for SL transmissions. The timeline 400 shows a feedback configuration for the UE including a first SL HARQ report 406a for the first PSFCH occasion 302a and a second SL HARQ report 406b for the PSFCH occasion 302b retransmission. Generally, because the UE is operating using the unlicensed spectrum, LBT failure is possible, and multiple PSFCH transmission occasions 302a, 302b may be required. This is in contrast to the licensed spectrum in which a single PSFCH occasion is used.

The UE determines each of the candidate PSFCH occasions 302a-b. For example, the UE determines for each SL HARQ report 406a-b for each respective PSFCH occasion 306a-b. The UE obtains a first time gap 404a between the first PSFCH occasion 302a and the first SL HARQ report to the base station 406a. The time gap 404a can be determined in a similar manner as time gap 304 described previously in relation to FIG. 3. The UE determines a second time gap 404b between the second PSFCH occasion 302b and the second SL HARQ report to the base station 406b. The time gap 404b can be determined in a similar manner as time gap 304 described previously in relation to FIG. 3.

The UE can determine each of the time gaps 404a, 404b individually. For example, when there are multiple PSFCH transmission occasions 302a-b to address LBT failure issue, multiple PUCCH occasions 406a-b are allocated, each occasion 406a-b corresponding to a respective candidate PSFCH transmission occasion 302a-b. The UE can use multiple different PSFCH-to-HARQ feedback timing indicator values in the DCI 3_0 data 202 to determine the time gaps 404a-b for the multiple PUCCH occasions 406a-b. In some implementations, a single value for the PSFCH-to-HARQ feedback timing indicator is received in the DCI 3_0. In this example, the UE determines each time gap 404a-b to be the same length.

In some implementations, the content of each SL HARQ report 406a-b to the base station (e.g., base station 104 of FIG. 1) depends on the corresponding PSFCH feedback of the occasions 302a-b. For example, the UE can perform SL unicast. In this case, if a HARQ ACK is received by the UE in the PSFCH occasions 302a or 302b, the UE sends the SL HARQ report 406a or 406b to the base station as an “ACK” transmission, respectively. If no HARQ ACK is received by the UE in any of the PSFCH occasions 302a or 302b, the UE sends the SL HARQ report 406a or 406b to the base station as a “NACK” transmission, respectively.

The UE can perform a SL groupcast ACK/NACK transmission. In this case, if a HARQ ACK is received by the UE for each of the PSFCH occasions 302a or 302b, the UE sends the SL HARQ report 406a or 406b to the base station as an “ACK” transmission, respectively. If any PSFCH occasion 302a or 302b received by the UE does not include a HARQ ACK, the UE sends the SL HARQ report 406a or 406b to the base station as a “NACK” transmission, respectively.

The UE can perform a SL groupcast NACK-only transmission. In this case, if a HARQ NACK is received by the UE for any of the PSFCH occasions 302a or 302b, the UE sends the SL HARQ report 406a or 406b to the base station as a “NACK” transmission, respectively. If no PSFCH occasion 302a or 302b received by the UE includes a HARQ NACK, the UE sends the SL HARQ report 406a or 406b to the base station as an “ACK” transmission, respectively.

The UE can change the content or transmission of the second report 406b based on the contents of the first report 406a. In an example, if the UE reports a SL HARQ ACK in an earlier PUCCH occasion 406a, the UE does not use later PUCCH occasions such as report 406b. In another example, if the UE reports a SL HARQ ACK in an earlier report 406a, the UE also reports the SL HARQ ACK for the subsequent PUSCH occasions, such as for report 406b. In another example, if the UE reports a SL HARQ ACK in an earlier PUSCH occasion 406a, the contents of the SL HARQ report 406b depends on the corresponding PSFCH feedback occasion 302b. The reports 406a-b therefore correspond to the outcomes of the corresponding PSFHCH occasions 302a-b.

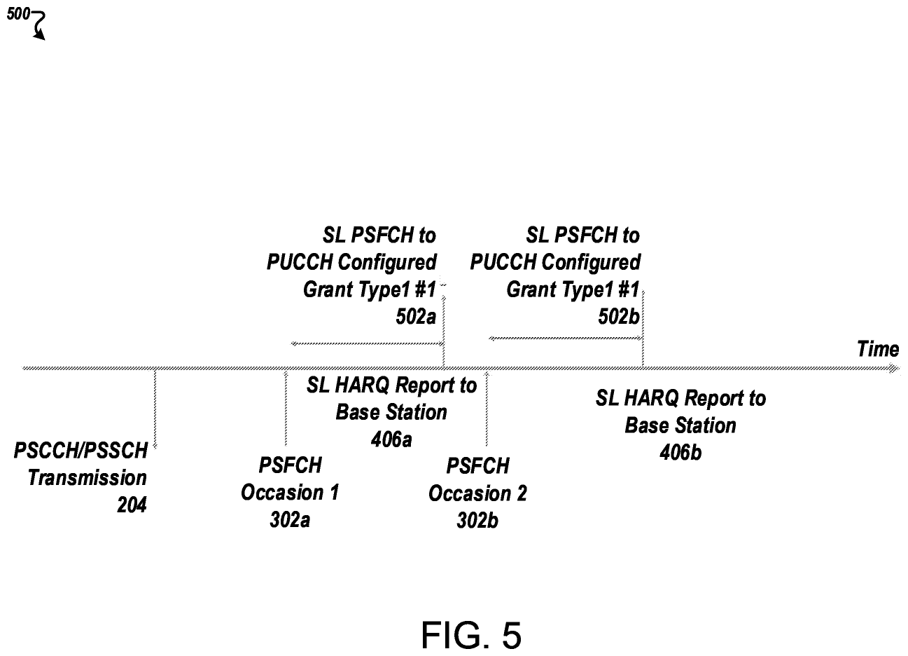

FIG. 5 shows an illustration of an example transmission timeline 500 for a UE (e.g., UE 102 of FIG. 1) for configured grant Type 1 SL transmissions. The timeline 500 is not based on the DCI 3_0 messages, but based on RRC messages. The configured grant transmissions are responsive to the LBT failure that may occur in the unlicensed spectrum. A list of fields called “sl-PSICH-ToPUCCH-CG-Type1” may be configured for the UE. When multiple PUCCH occasions 302a-b are allocated for the UE, a configured grant transmission occasion time gap 502a-b is allocated for each corresponding candidate PSFCH transmission occasion 302a-b. The time gaps 502a-b represent the time between receipt of the PSFCH occasions 302a-b by the UE and the UE sending the corresponding reports 406a-b. Generally, a length of the list is equal to the number of candidate PSFCH occasions 302a-b.

In some implementations, a list of fields “sl-TimeResourceCG-Type1” and “sl-FreqResourceCG-Type1” are configured by the UE. These configure the time and frequency resources, respectively, for each PSFCH occasion 302a-b and any response transmissions 406a-b by the UE.

The multiple PSCCH/PSSCH transmission opportunities mitigate negative outcomes from LBT failure. As previously described with respect to time gaps for sending reports 406a-b to the base station responsive to PSFCH occasions 302a-b, the time gaps 502a-b can be configured together (and possibly be identical) or they each be configured independently and each have a different length from one or more other time gaps.

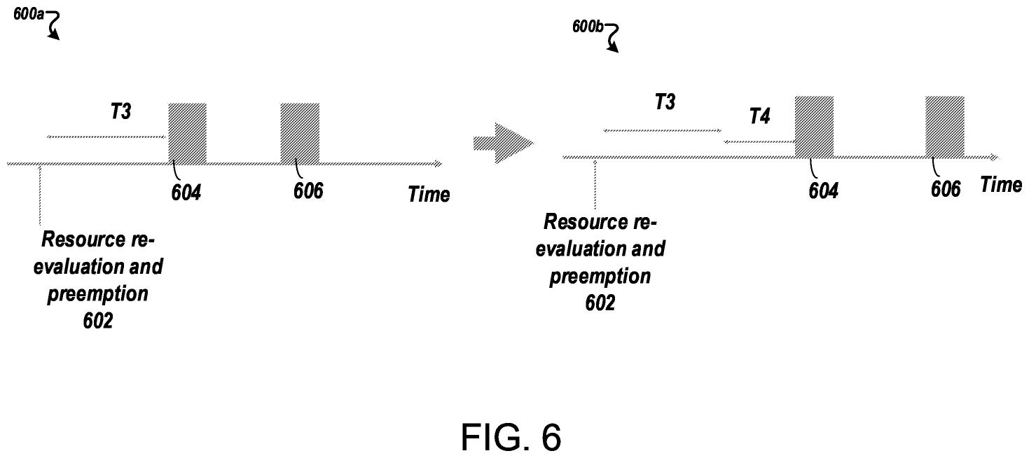

FIG. 6 shows an illustration of example transmission timelines 600a-b for a UE (e.g., UE 102 of FIG. 1) for SL transmissions. Timeline 600a shows an example of the reevaluation or preemption of allocated resources for the licensed spectrum. Timeline 600b shows an example of the reevaluation or preemption of allocated resources for the unlicensed spectrum. The time T₃ is needed for data processing and preparation prior to the use of allocated slot 602.

As shown in timeline 600a, the reevaluation or preemption of resources 602 for slot 604 is mandatorily performed at a specified time T₃ prior to the occurrence of slot 604. For NR sidelink on the unlicensed spectrum, the time gap of T₃ prior to slot 602 is not enough because LBT operations performed before SL transmission take some additional time. As shown in timeline 600b, for the unlicensed spectrum, the time gap T₃ for resource reevaluation and preemption for slot 602 is increased in length by time gap T₄. The increase T₄ to the time gap T₃ enables the UE to perform LBT operations prior to SL transmission in addition to other functions for preparing the UE to use allocated slot 602.

The value of T₄ is configured by the UE as follows. The value of T₄ may depend on a value of the CAPC index of the data transmission. For example, a larger CAPC index can correspond to a larger the value of the added time T₄ to time gap T₃ for resource revaluation and preemption. In some implementations, the value of T₄ is (pre)configured per resource pool. In some implementations, the value of T₄ is predefined and/or static. In some implementations, the value of T₄ depends on sub-carrier spacing. For example, if the sub-carrier spacing (SCS) is larger, the value of T₄ is correspondingly larger. In some implementations, the LBT operations can fail for the UE. In this case, the slot 602 is dropped and the next slot 604 is allocated. The time gap T₃ plus T₄ is then used for resource preemption or revaluation prior to slot 604.

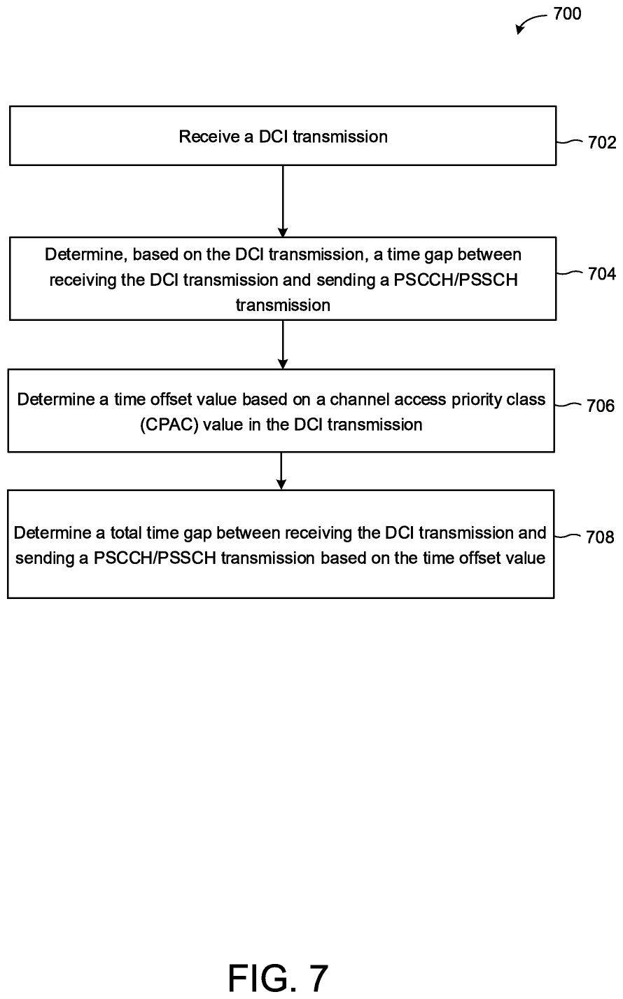

FIGS. 7, 8, 9, 10, and 11, show example processes performed by a UE for resource allocation for sidelink transmissions in unlicensed spectrum for mode 1. In some embodiments, the electronic device(s), network(s), system(s), chip(s) or component(s), or portions or implementations thereof, of FIGS. 1-6, or some other figure, may be configured to perform one or more processes, techniques, or methods as described herein, or portions thereof. One such process 700 is depicted in FIG. 7. The process 700 may be performed by a UE, such as UE 102 of FIG. 1

For the process 700 shown in FIG. 7, a UE receives (702) a DCI transmission. As previously described, the DCI transmission includes a field that specifies a time gap value. The time gap value indicates a time gap between receiving the DCI transmission by the UE and the transmission of a PSCCH/PSSCH signal by the UE. The time gap specified by the DCI transmission is large enough to allow the UE to perform LBT operations.

The UE is configured to determine (704), based on the DCI transmission, a time gap between receiving the DCI transmission and sending a PSCCH/PSSCH transmission. The time gap can be identical to the time gap value specified in the DCI time gap field. In some implementations, the time gap can be adjusted. For example, the process can include determining (706) a time offset value based on a channel access priority class (CPAC) value in the DCI transmission. The offset value enables the UE to perform LBT operations. In some implementations, the offset value is related to the CAPC index such that when the CAPC index value is larger, the offset is larger. The mapping between the CAPC index values and the corresponding offset values can be predefined or configured per resource pool. The UE is configured to determine (708) a total time gap between receiving the DCI transmission and sending a PSCCH/PSSCH transmission based on the time offset value.

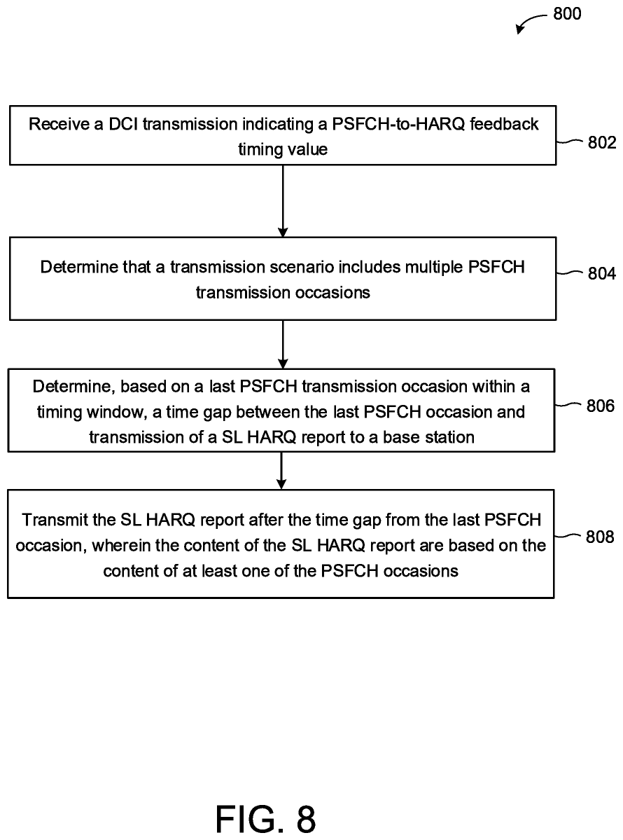

FIG. 8 shows an example process 800 performed by a UE for resource allocation for sidelink transmissions in unlicensed spectrum for mode 1. The process 800 may be performed by a UE, such as UE 102 of FIG. 1

The process 800 includes receiving (802) a DCI transmission indicating a PSFCH-to-HARQ feedback timing value. The PSFCH-to-HARQ feedback timing value represents a timing of a PUCCH transmission with respect to a SL HARQ report by the UE to a base station (e.g., base station 104 of FIG. 1). The UE is configured to determine (804) that a transmission scenario includes multiple PSFCH transmission occasions. The UE can configure a single time gap for between a last PSFCH occasion in a time window and a respective SL HARQ feedback report to a base station.

The UE is configured to determine (806), based on the last PSFCH transmission occasion within a timing window, the time gap between the last PSFCH occasion and transmission of a SL HARQ report to a base station. The UE is configured to transmit (806) the SL HARQ report after the time gap from the last PSFCH occasion. The content of the SL HARQ report are based on the content of at least one of the PSFCH occasions. For example, the UE can perform SL unicast. In this case, if a HARQ ACK is received by the UE in any of the PSFCH occasions, the UE sends the SL HARQ report to the base station as an “ACK” transmission. If no HARQ ACK is received by the UE in any of the PSFCH occasions, the UE sends the SL HARQ report to the base station as a “NACK” transmission.

The UE can perform SL groupcast ACK/NACK transmission. In this case, if a HARQ ACK is received by the UE for each of the PSFCH occasions, the UE sends the SL HARQ report to the base station as an “ACK” transmission. If any PSFCH occasion received by the UE does not include a HARQ ACK, the UE sends the SL HARQ report to the base station as a “NACK” transmission.

The UE can perform SL groupcast NACK-only transmission. In this case, if a HARQ NACK is received by the UE for any of the PSFCH occasions, the UE sends the SL HARQ report to the base station as a “NACK” transmission. If no PSFCH occasion received by the UE includes a HARQ NACK, the UE sends the SL HARQ report to the base station as an “ACK” transmission. The UE reporting to the base station is either ACK/NACK, thought the UE-UE transmissions are NACK only. This is because the base station determines whether to schedule for retransmission based on the received ACK/NACK data in the report.

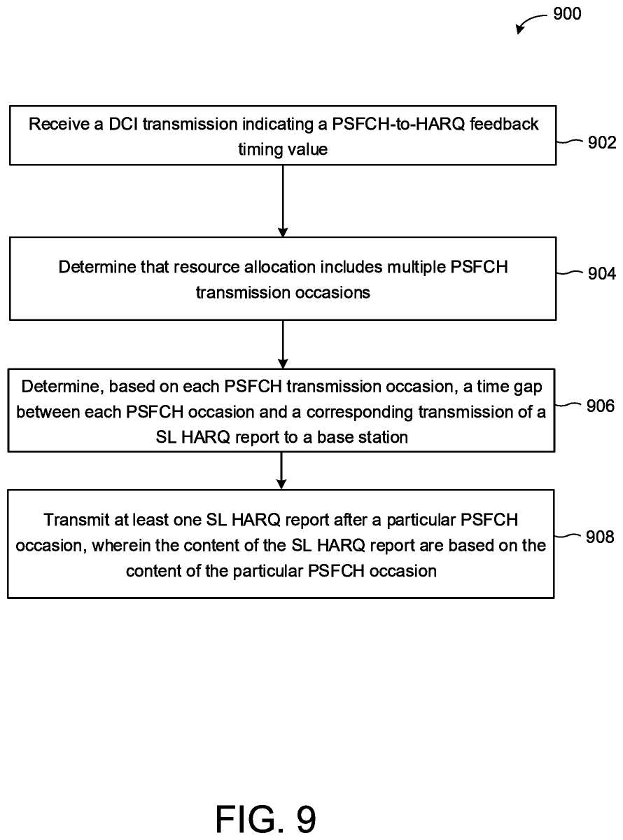

FIG. 9 shows an example process 900 performed by a UE for resource allocation for sidelink transmissions in unlicensed spectrum for mode 1. The process 900 may be performed by a UE, such as UE 102 of FIG. 1. The UE is configured to receive (902) a DCI transmission indicating a PSFCH-to-HARQ feedback timing value. The UE is configured to determine (904) that a resource allocation includes multiple PSFCH transmission occasions. In some implementations, the multiple PSFCH occasions are included to accommodate potential LBT failure, and thus subsequent PSFCH retransmission. The UE is configured to determine (906), based on each PSFCH transmission occasion allocation, a time gap between each PSFCH occasion and a corresponding transmission of a SL HARQ report to a base station. In some implementations, the time gaps are the same length for each associated PSFCH occasion. In some implementations, the time gap associated with each PSFCH occasion is configured independently from other PSFCH occasions. In some implementations, the time gaps associated with respective PSFCH occasions have different lengths. The UE is configured to transmit (908) at least one SL HARQ report after a particular PSFCH occasion. The contents of the SL HARQ report (e.g., ACK/NACK) are based on the contents of the particular corresponding PSFCH occasion.

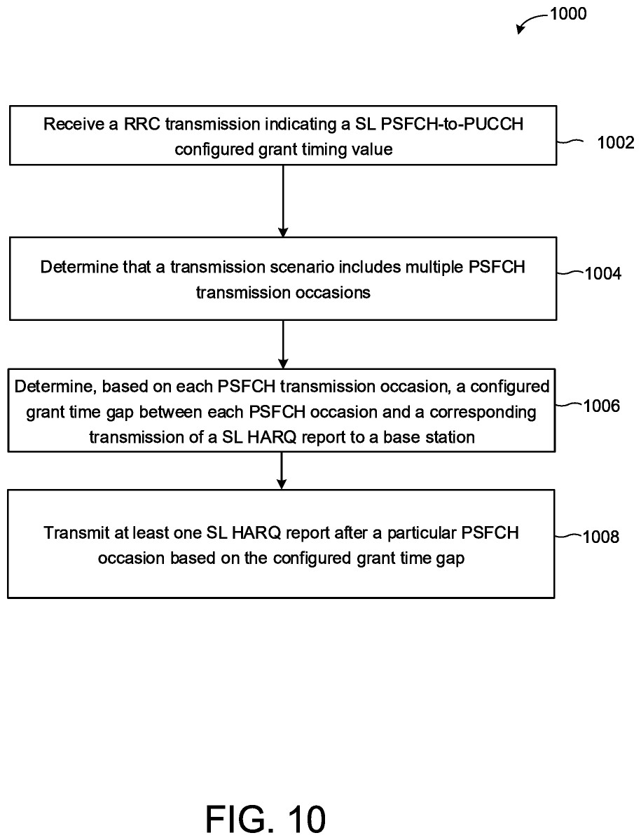

FIG. 10 shows an example process 1000 performed by a UE for resource allocation for sidelink transmissions in unlicensed spectrum for mode 1. The process 1000 may be performed by a UE, such as UE 102 of FIG. 1. The process 1000 is performed by RRC messaging. The UE is configured to receive (1002) a RRC transmission indicating a SL PSFCH-to-PUCCH configured grant timing value. The UE is configured to determine (1004) that a resource allocation includes multiple PSFCH transmission occasions. In some implementations, the multiple PSFCH occasions are included to accommodate potential LBT failure for the UE, and enable a subsequent PSFCH retransmission. The UE is configured to determine (1006), based on each PSFCH transmission occasion allocation, a configured grant time gap between each PSFCH occasion and a corresponding transmission of a SL HARQ report to a base station. In some implementations, the configured grant time gaps are the same length for each associated PSFCH occasion. In some implementations, the configured grant time gap associated with each PSFCH occasion is configured independently from other PSFCH occasions. In some implementations, the configured grant time gaps associated with respective PSFCH occasions have different lengths. The UE is configured to transmit (1008), based on the configured grant time gap, at least one SL HARQ report after a particular PSFCH occasion. The contents of the SL HARQ report (e.g., ACK/NACK) are based on the contents of the particular corresponding PSFCH occasion.

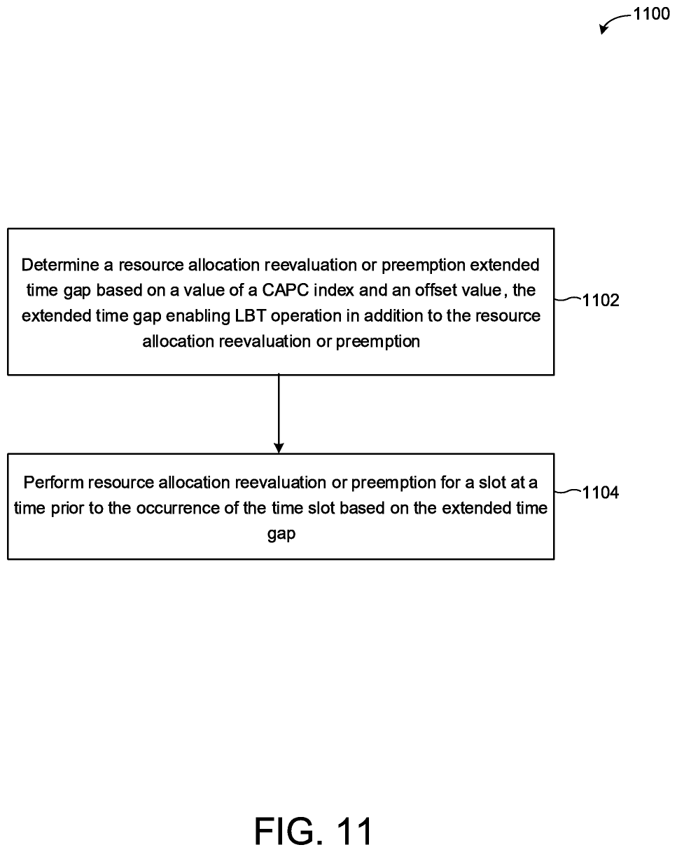

FIG. 11 shows an example process 1100 performed by a UE for resource allocation for sidelink transmissions in unlicensed spectrum for mode 1. The process 1100 may be performed by a UE, such as UE 102 of FIG. 1. The UE determines (1102) a resource allocation reevaluation or preemption extended time gap. The resource allocation reevaluation extended time gap includes an offset time gap added to a base time gap. The base time gap depends on a value of a CAPC index. The base the time gap enables the UE to prepare for transmission or reception for a given slot. The added offset time gap enables the UE to perform LBT operation in addition to the resource allocation reevaluation or preemption for the slot. The UE performs (1104) resource allocation reevaluation or preemption for the slot at a time prior to the occurrence of the slot based on the extended time gap.

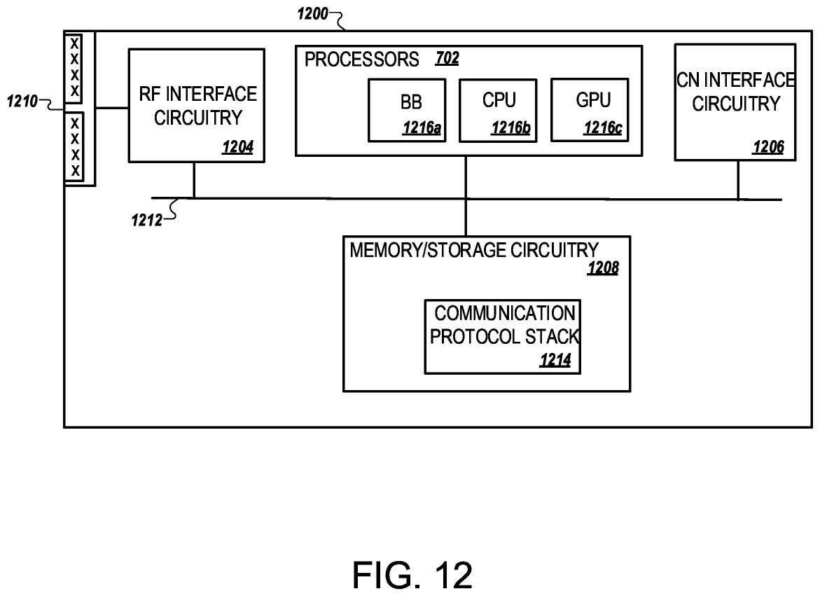

FIG. 12 illustrates an access node 1200 (e.g., a base station or gNB), in accordance with some embodiments. The access node 1200 may be similar to and substantially interchangeable with base station 104. The access node 1200 may include processors 1202, RF interface circuitry 1204, core network (CN) interface circuitry 1206, memory/storage circuitry 1208, and antenna structure 1210.

The components of the access node 1200 may be coupled with various other components over one or more interconnects 1212. The processors 1202, RF interface circuitry 1204, memory/storage circuitry 1208 (including communication protocol stack 1214), antenna structure 1210, and interconnects 1212 may be similar to like-named elements shown and described with respect to FIG. 8. For example, the processors 1202 may include processor circuitry such as, for example, baseband processor circuitry (BB) 1216A, central processor unit circuitry (CPU) 1216B, and graphics processor unit circuitry (GPU) 1216C.

The CN interface circuitry 1206 may provide connectivity to a core network, for example, a 5th Generation Core network (5GC) using a 5GC-compatible network interface protocol such as carrier Ethernet protocols, or some other suitable protocol. Network connectivity may be provided to/from the access node 1200 via a fiber optic or wireless backhaul. The CN interface circuitry 1206 may include one or more dedicated processors or FPGAs to communicate using one or more of the aforementioned protocols. In some implementations, the CN interface circuitry 1206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1200 that operates in an NR or 5G system (for example, a gNB), and the term “E-UTRAN node” or the like may refer to an access node 1200 that operates in an LTE or 4G system (e.g., an eNB). According to various embodiments, the access node 1200 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 1200 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 1200; a MAC/PHY split wherein RRC, PDCP, RLC, and MAC layers are operated by the CRAN/vBBUP and the PHY layer is operated by the access node 1200; or a “lower PHY” split wherein RRC, PDCP, RLC, MAC layers and upper portions of the PHY layer are operated by the CRAN/vBBUP and lower portions of the PHY layer are operated by the access node 1200.

In V2X scenarios, the access node 1200 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

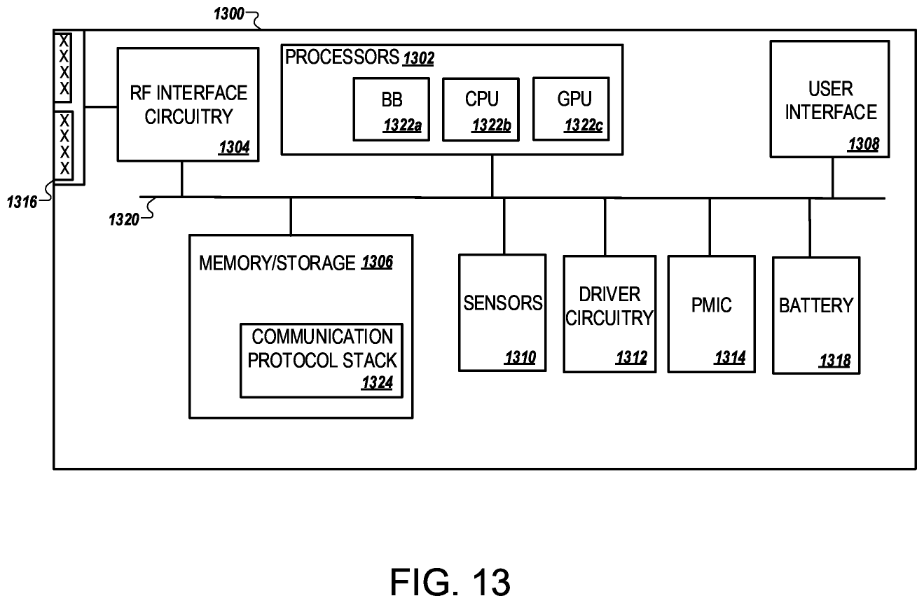

FIG. 13 illustrates a UE 1300, in accordance with some embodiments. The UE 1300 may be similar to and substantially interchangeable with UE 102 of FIG. 1. The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1300 may include processors 1302, RF interface circuitry 1304, memory/storage 1306, user interface 1308, sensors 1310, driver circuitry 1312, power management integrated circuit (PMIC) 1314, antenna structure 1316, and battery 1318. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangement of the components shown may occur in other implementations.

The components of the UE 1300 may be coupled with various other components over one or more interconnects 1320, which may represent any type of interface, input/output, bus (local, system, or expansion), transmission line, trace, optical connection, etc. that allows various circuit components (on common or different chips or chipsets) to interact with one another.

The processors 1302 may include processor circuitry such as, for example, baseband processor circuitry (BB) 1322A, central processor unit circuitry (CPU) 1322B, and graphics processor unit circuitry (GPU) 1322C. The processors 1302 may include any type of circuitry or processor circuitry that executes or otherwise operates computer-executable instructions, such as program code, software modules, or functional processes from memory/storage 1306 to cause the UE 1300 to perform operations as described herein.

In some embodiments, the baseband processor circuitry 1322A may access a communication protocol stack 1324 in the memory/storage 1306 to communicate over a 3GPP compatible network. In general, the baseband processor circuitry 1322A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1304. The baseband processor circuitry 1322A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1306 may include one or more non-transitory, computer-readable media that includes instructions (for example, communication protocol stack 1324) that may be executed by one or more of the processors 1302 to cause the UE 1300 to perform various operations described herein. The memory/storage 1306 include any type of volatile or non-volatile memory that may be distributed throughout the UE 1300. In some embodiments, some of the memory/storage 1306 may be located on the processors 1302 themselves (for example, L1 and L2 cache), while other memory/storage 1306 is external to the processors 1302 but accessible thereto via a memory interface. The memory/storage 1306 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1304 may include transceiver circuitry and radio frequency front module (RFEM) that allows the UE 1300 to communicate with other devices over a radio access network. The RF interface circuitry 1304 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1316 and proceed to filter and amplify (with a low-noise amplifier) the signal. The signal may be provided to a receiver of the transceiver that downconverts the RF signal into a baseband signal that is provided to the baseband processor of the processors 1302.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1316.

In various embodiments, the RF interface circuitry 1304 may be configured to transmit/receive signals in a manner compatible with NR access technologies.

The antenna 1316 may include antenna elements to convert electrical signals into radio waves to travel through the air and to convert received radio waves into electrical signals. The antenna elements may be arranged into one or more antenna panels. The antenna 1316 may have antenna panels that are omnidirectional, directional, or a combination thereof to enable beamforming and multiple input, multiple output communications. The antenna 1316 may include microstrip antennas, printed antennas fabricated on the surface of one or more printed circuit boards, patch antennas, phased array antennas, etc. The antenna 1316 may have one or more panels designed for specific frequency bands including bands in FR1 or FR2.

The user interface 1308 includes various input/output (I/O) devices designed to enable user interaction with the UE 1300. The user interface 1308 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1300.

The sensors 1310 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1312 may include software and hardware elements that operate to control particular devices that are embedded in the UE 1300, attached to the UE 1300, or otherwise communicatively coupled with the UE 1300. The driver circuitry 1312 may include individual drivers allowing other components to interact with or control various input/output (I/O) devices that may be present within, or connected to, the UE 1300. For example, driver circuitry 1312 may include a display driver to control and allow access to a display device, a touchscreen driver to control and allow access to a touchscreen interface, sensor drivers to obtain sensor readings of sensor circuitry 1328 and control and allow access to sensor circuitry 1328, drivers to obtain actuator positions of electro-mechanic components or control and allow access to the electro-mechanic components, a camera driver to control and allow access to an embedded image capture device, audio drivers to control and allow access to one or more audio devices.

The PMIC 1314 may manage power provided to various components of the UE 1300. In particular, with respect to the processors 1302, the PMIC 1314 may control power-source selection, voltage scaling, battery charging, or DC-to-DC conversion.

In some embodiments, the PMIC 1314 may control, or otherwise be part of, various power saving mechanisms of the UE 1300 including DRX as discussed herein. A battery 1318 may power the UE 1300, although in some examples the UE 1300 may be mounted deployed in a fixed location, and may have a power supply coupled to an electrical grid. The battery 1318 may be a lithium ion battery, a metal-air battery, such as a zinc-air battery, an aluminum-air battery, a lithium-air battery, and the like. In some implementations, such as in vehicle-based applications, the battery 1318 may be a typical lead-acid automotive battery.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method for performing a sidelink (SL) communication, the method including receiving, by a user equipment (UE), a downlink control information (DCI) transmission. The method includes determining, based on the DCI transmission, an initial time gap between receipt of the DCI transmission and a transmission, allocated for the UE, of a physical sidelink control channel or a physical sidelink shared channel (PSCCH/PSSCH). The method includes determining a time offset value based on a channel access priority class (CPAC) value included in the DCI transmission. The method includes determining a total time gap between receiving the DCI transmission at the UE and sending the PSCCH or PSSCH transmission by the UE based on the initial time gap and the time offset. The method includes sending the PSCCH or PSSCH transmission based on the total time gap.

Example 2 includes the method of at least example 1, wherein the DCI transmission includes a field storing a value representing the initial time gap.

Example 3 includes the methods of examples 1 or 2, wherein the DCI transmission includes a field indicating an index value, the index value being associated with a sl-DCI-ToSL-Trans table storing a value of the time gap.

Example 4 includes the methods of examples 1-3, wherein the total time gap enables the UE to perform listen before talk (LBT) operations.

Example 5 includes the methods of examples 1-4, wherein the CAPC value is pre-mapped to the offset value per resource pool.

Example 6 includes a method for performing a sidelink (SL) communication, the method including receiving, by a user equipment (UE), a downlink control information (DCI) transmission indicating a Physical Sidelink Feedback Channel to Hybrid Automatic Repeat Request (PSFCH-to-HARQ) feedback timing indicator value. The method includes determining, based on the PSFCH-to-HARQ feedback timing indicator value, a time gap between a PSFCH occasion for the UE and a transmission time for a sidelink (SL) HARQ report by the UE to a base station. The method includes transmitting the SL HARQ report after the PSFCH occasion based on the time gap.

Example 7 includes the method of example 6, and further includes determining that the PSFCH occasion is one of a plurality of PSFCH occasions. The method further includes determining a last scheduled PSFCH occasion of the plurality of PSFCH occasions. The method further includes determining the transmission time for the SL HARQ report by the UE to the base station based on the time gap and the last PSFCH occasion.

Example 8 includes the methods of examples 6-7, wherein content the SL HARQ feedback is based on a content of the PSFCH occasion.

Example 9 includes the methods of examples 6-8, wherein the content of the SL HARQ feedback comprises an ACK signal responsive to at least one PSFCH occasion of a plurality of PSFCH occasions including an ACK signal.

Example 10 includes the methods of examples 6-9, wherein the content of the SL HARQ feedback comprises an ACK signal responsive to each PSFCH occasion of a plurality of PSFCH occasions including a respective ACK signal.

Example 11 includes the methods of examples 6-10, wherein the content of the SL HARQ feedback comprises a NACK signal responsive to at least one PSFCH occasion of a plurality of PSFCH occasions including a NACK signal.

Example 12 includes the methods of examples 6-11, the method further including determining that the PSFCH occasion is one of a plurality of PSFCH occasions. The method further includes determining a first time gap between a first PSFCH occasion of the plurality and a first SL HARQ report by the UE based on a first PSFCH-to-HARQ feedback timing indicator value included in the DCI transmission. The method further includes determining a second time gap between a second PSFCH occasion of the plurality and a second SL HARQ report by the UE based on a second PSFCH-to-HARQ feedback timing indicator value included in the DCI transmission. The method further includes determining a first transmission time for the first SL HARQ report by the UE to the base station based on the first time gap. The method further includes determining a second transmission time for the second SL HARQ report by the UE to the base station based on the second time gap. The method includes transmitting the first SL HARQ report based on the first time gap. The method includes transmitting the second SL HARQ report based on the second time gap.

Example 13 includes the method of example 12, wherein the first time gap is the same length as the second time gap.

Example 14 includes the methods of examples 12-13, wherein the first time gap is a different length from the second time gap.

Example 15 includes the methods of examples 12-14, the method further including determining that the first SL HARQ report includes an ACK signal, wherein the second SL HARQ report is not transmitted in response to the determining.

Example 16 includes a method for performing a sidelink (SL) communication. The method includes receiving, by a user equipment (UE), a radio resource control (RRC) transmission indicating a sidelink Physical Sidelink Feedback Channel to Physical Uplink Control Channel (PSFCH-to-PUCCH) configured grant timing value. The method includes determining, based on a PSFCH transmission occasion and the configured grant timing value, a configured grant time gap between the PSFCH occasion and a corresponding transmission by the UE of a SL HARQ report to a base station. The method includes transmitting the SL HARQ report based on the configured grant time gap.

Example 17 includes the method of example 16, further including transmitting at least one SL HARQ report after the PSFCH occasion based on the configured grant time gap.

Example 18 includes the methods of examples 16-17, wherein the configured grant time gap is long enough to enable listen before talk (LBT) operations by the UE.

Example 19 includes the methods of examples 16-18, the method further comprising determining, for a slot, a resource reevaluation or preemption time gap.

Example 20 includes the methods of examples 16-19, wherein the resource reevaluation or preemption time gap comprises an offset extension configured to enable LBT operations by the UE.

Example 21 may include an apparatus comprising means to perform one or more elements of a method described in or related to any of examples 1-20, or any other method or process described herein.

Example 22 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 23 may include an apparatus comprising logic, modules, or circuitry to perform one or more elements of a method described in or related to any of examples 1-20, or any other method or process described herein.

Example 24 may include a method, technique, or process as described in or related to any of examples 1-20, or portions or parts thereof.

Example 25 may include an apparatus comprising: one or more processors and one or more computer-readable media comprising instructions that, when executed by the one or more processors, cause the one or more processors to perform the method, techniques, or process as described in or related to any of examples 1-20, or portions thereof.

Example 26 may include a signal as described in or related to any of examples 1-25, or portions or parts thereof.

Example 27 may include a datagram, packet, frame, segment, protocol data unit (PDU), or message as described in or related to any of examples 1-26, or portions or parts thereof, or otherwise described in the present disclosure.

Example 28 may include a signal encoded with data as described in or related to any of examples 1-26, or portions or parts thereof, or otherwise described in the present disclosure.

Example 29 may include a signal encoded with a datagram, packet, frame, segment, protocol data unit (PDU), or message as described in or related to any of examples 1-26, or portions or parts thereof, or otherwise described in the present disclosure.

Example 30 may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Example 31 may include a computer program comprising instructions, wherein execution of the program by a processing element is to cause the processing element to carry out the method, techniques, or process as described in or related to any of examples 1-20, or portions thereof.

Example 32 may include a signal in a wireless network as shown and described herein.

Example 33 may include a method of communicating in a wireless network as shown and described herein.

Example 34 may include a system for providing wireless communication as shown and described herein.

Example 35 may include a device for providing wireless communication as shown and described herein.

Example 36 may include an apparatus as described in or related to any of any one of examples 1-26, wherein the apparatus or any portion thereof is implemented in or by a user equipment (UE).

Example 37 may include a method as described in or related to any of any one of examples 1-26, wherein the method or any portion thereof is implemented in or by a user equipment (UE).

Example 38 may include an apparatus as described in or related to any of any one of examples 1-26, wherein the apparatus or any portion thereof is implemented in or by a base station (BS).

Example 39 may include a method as described in or related to any of any one of examples 1-26, wherein the method or any portion thereof is implemented in or by a base station (BS).

Example 40 may include an apparatus as described in or related to any of any one of examples 1-26, wherein the apparatus or any portion thereof is implemented in or by a network element.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to execute instructions stored in memory to perform operations comprising:
receiving, by a user equipment (UE), a downlink control information (DCI) transmission;
determining, based on the DCI transmission, an initial time gap between receipt of the DCI transmission and a transmission of a physical sidelink control channel or a physical sidelink shared channel (PSCCH/PSSCH);
determining a time offset value based on a channel access priority class (CPAC) value included in the DCI transmission;
determining a total time gap between receiving the DCI transmission at the UE and sending the PSCCH or PSSCH transmission by the UE based on the initial time gap and the time offset; and
sending the PSCCH or PSSCH transmission based on the total time gap.

2. The one or more processors of claim 1, wherein the DCI transmission includes a field storing a value representing the initial time gap.

3. The one or more processors of claim 1, wherein the DCI transmission includes a field indicating an index value, the index value being associated with a sl-DCI-ToSL-Trans table storing a value of the time gap.

4. The one or more processors of claim 1, wherein the total time gap enables the UE to perform listen before talk (LBT) operations.

5. The one or more processors of claim 1, wherein the CAPC value is pre-mapped to the offset value per resource pool.

6. A method for performing a sidelink (SL) communication, the method comprising:
receiving, by a user equipment (UE), a downlink control information (DCI) transmission indicating a Physical Sidelink Feedback Channel to Hybrid Automatic Repeat Request (PSFCH-to-HARQ) feedback timing indicator value;
determining, based on the PSFCH-to-HARQ feedback timing indicator value, a time gap between a PSFCH occasion for the UE and a transmission time for a sidelink (SL) HARQ report by the UE to a base station; and
transmitting the SL HARQ report after the PSFCH occasion based on the time gap.

7. The method of claim 6, further comprising:
determining that the PSFCH occasion is one of a plurality of PSFCH occasions;
determining a last scheduled PSFCH occasion of the plurality of PSFCH occasions; and
determining the transmission time for the SL HARQ report by the UE to the base station based on the time gap and the last PSFCH occasion.

8. The method of claim 6, wherein content the SL HARQ feedback is based on a content of the PSFCH occasion.

9. The method of claim 8, wherein the content of the SL HARQ feedback comprises an ACK signal responsive to at least one PSFCH occasion of a plurality of PSFCH occasions including an ACK signal.

10. The method of claim 8, wherein the content of the SL HARQ feedback comprises an ACK signal responsive to each PSFCH occasion of a plurality of PSFCH occasions including a respective ACK signal.

11. The method of claim 8, wherein the content of the SL HARQ feedback comprises a NACK signal responsive to at least one PSFCH occasion of a plurality of PSFCH occasions including a NACK signal.

12. The method of claim 6, further comprising:
determining that the PSFCH occasion is one of a plurality of PSFCH occasions;
determining a first time gap between a first PSFCH occasion of the plurality and a first SL HARQ report by the UE based on a first PSFCH-to-HARQ feedback timing indicator value included in the DCI transmission;
determining a second time gap between a second PSFCH occasion of the plurality and a second SL HARQ report by the UE based on a second PSFCH-to-HARQ feedback timing indicator value included in the DCI transmission;
determining a first transmission time for the first SL HARQ report by the UE to the base station based on the first time gap; and
determining a second transmission time for the second SL HARQ report by the UE to the base station based on the second time gap; and
transmitting the first SL HARQ report based on the first time gap; and
transmitting the second SL HARQ report based on the second time gap.

13. The method of claim 12, wherein the first time gap is the same length as the second time gap.

14. The method of claim 12, wherein the first time gap is a different length from the second time gap.

15. The method of claim 12, further comprising:
determining that the first SL HARQ report includes an ACK signal, wherein the second SL HARQ report is not transmitted in response to the determining.

16. One or more processors configured to execute instructions stored in memory to perform operations comprising:
receiving, by a user equipment (UE), a radio resource control (RRC) transmission indicating a sidelink Physical Sidelink Feedback Channel to Physical Uplink Control Channel (PSFCH-to-PUCCH) configured grant timing value; and
determine, based on a PSFCH transmission occasion and the configured grant timing value, a configured grant time gap between the PSFCH occasion and a corresponding transmission by the UE of a SL HARQ report to a base station; and
transmitting the SL HARQ report based on the configured grant time gap.

17. The one or more processors of claim 16, further comprising transmitting at least one SL HARQ report after the PSFCH occasion based on the configured grant time gap.

18. The one or more processors of claim 16, wherein the configured grant time gap is long enough to enable listen before talk (LBT) operations by the UE.

19. The one or more processors of claim 16, further comprising determining, for a slot, a resource reevaluation or preemption time gap.

20. The one or more processors of claim 19, wherein the resource reevaluation or preemption time gap comprises an offset extension configured to enable LBT operations by the UE.
